(19) United States
(12) Patent Application Publication
(10) Pub. No.: US 2015/0087328 A1
(43) Pub. Date: Mar. 26, 2015

(54) METHOD AND APPARATUS FOR IMPROVING POSITIONING ACCURACY OF A MOBILE DEVICE WITH A LOWER POSITIONING CAPABILITY

(71) Applicant: QUALCOMM Incorporated, San Diego, CA (US)

(72) Inventors: Hui Chao, San Jose, CA (US); Kirk Allan Burroughs, Alamo, CA (US); Vinay Sridhara, Santa Clara, CA (US); Saumitra Mohan Das, Santa Clara, CA (US)

(73) Assignee: QUALCOMM Incorporated, San Diego, CA (US)

(21) Appl. No.: 14/034,089

(22) Filed: Sep. 23, 2013

(51) Int. Cl. H04W 64/00

(52) U.S. Cl. CPC H04W 64/00
USPC 455/456.1

(57) ABSTRACT

Example methods, apparatuses, or articles of manufacture are disclosed herein that may be utilized, in whole or in part, to facilitate or support one or more operations or techniques for improving positioning accuracy of a mobile device with a lower positioning capability, such as, for example, via one or more proximate mobile devices with a higher positioning capability.

### BACKGROUND

1. Field

The present disclosure relates generally to position estimation techniques and, more particularly, to improving positioning accuracy of a mobile communication device with a lower positioning capability, such as, for example, via one or more proximate mobile communication devices with a higher positioning capability.

2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or the like may assist users in estimating their geographic locations by providing position information obtained or gathered from various systems. For example, in an outdoor environment, certain mobile communication devices may obtain a position estimate or so-called “position fix” by acquiring wireless signals from a satellite positioning system (SPS), such as the global positioning system (GPS) or other like Global Navigation Satellite System (GNSS), cellular base station, location beacon, etc. via a cellular telephone or like wireless communications network. In some instances, received wireless signals may be processed by or at a mobile communication device, and its location may be estimated using known techniques, such as, for example, Advanced Forward Link Trilateration (AFLT), base station identification, or the like.

In some instances, such as in an indoor or like environment, for example, mobile communication devices may be unable to reliably receive or acquire satellite or like wireless signals to facilitate or support one or more position estimation techniques. For example, wireless signals from an SPS or like system may be attenuated or otherwise affected in some manner (e.g., insufficient, weak, fragmentary, etc.), which may at least partially preclude their use for position operations. As such, in an indoor environment, different techniques may be employed to enable navigation or location services. For example, at times, a mobile communication device located indoors may obtain a position fix via determining locations of and measuring ranges to three or more nearby mobile communication devices located outdoors (e.g., just outside a building, etc.). Ranges may be measured, for example, by obtaining a Media Access Control identifier (MAC ID) address and measuring one or more characteristics of received signals, such as signal strength, round trip delay, or the like. Locations of nearby mobile communication devices may, for example, be determined via one or more wireless signals received from such devices and indicative of their locations (e.g., GPS coordinates, etc.). Based, at least in part, on determined locations and measured ranges, a mobile communication device located in an indoor environment may then estimate its own location using known techniques (e.g., triangulation, etc.).

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process for improving positioning accuracy of a mobile device with a lower positioning capability.

FIG. 3 is a flow diagram illustrating another implementation of an example process for improving positioning accuracy of a mobile device with a lower positioning capability.

FIG. 4 is an illustration of an implementation of an example trilateration operation.

FIG. 5 is a flow diagram of an implementation of a process illustrating an example use case of improving positioning accuracy of a mobile device with a lower positioning capability.

FIG. 6 is a schematic diagram illustrating an implementation of an example computing environment associated with a mobile device.

FIG. 7 is a schematic diagram illustrating an implementation of an example computing environment associated with a server.

### SUMMARY

Example implementations relate to improving positioning accuracy of a mobile communication device with a lower positioning capability, such as, for example, via one or more proximate mobile communication devices with a higher positioning capability. In one implementation, a method may comprise detecting, at a first mobile device, a presence of a second mobile device in close proximity to the first mobile device, the second mobile device having a higher positioning capability relative to the first mobile device; communicating an indication of the detected presence of the second mobile device to a server via a wireless communications network; receiving an estimate of a location of the second mobile device from the server based, at least in part, on the indication; and computing an estimated location of the first mobile device based, at least in part, on the estimate of the location of the second mobile device.

In another implementation, an apparatus may comprise a communication interface and at least one processor programmed with instructions to detect, at a first mobile device, a presence of a second mobile device in close proximity to the first mobile device, the second mobile device having a higher positioning capability relative to the first mobile device; communicate an indication of the detected presence of the second mobile device to a server via a wireless communications network; receive an estimate of a location of the second mobile device from the server based, at least in part, on the indication; and compute an estimated location of the first mobile device based, at least in part, on the estimate of the location of the second mobile device.

In yet another implementation, an apparatus may comprise means for detecting, at a first mobile device, a presence of a second mobile device in close proximity to the first mobile device, the second mobile device having a higher positioning capability relative to the first mobile device; means for communicating an indication of the detected presence of the second mobile device to a server via a wireless communications network; means for receiving an estimate of a location of the second mobile device from the server based, at least in part, on the indication; and means for computing an estimated location of the first mobile device based, at least in part, on the estimate of the location of the second mobile device.

In yet another implementation, an article may comprise a non-transitory storage medium having instructions stored thereon executable by a computing platform to detect, at a first mobile device, a presence of a second mobile device in close proximity to the first mobile device, the second mobile device having a higher positioning capability relative to the first mobile device; communicate an indication of the detected presence of the second mobile device to a server via a wireless communications network; receive an estimate of a location of the second mobile device from the server based, at least in part, on the indication; and compute an estimated location of the first mobile device based, at least in part, on the estimate of the location of the second mobile device. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations or techniques for improving positioning accuracy of a mobile communication device with a lower positioning capability, such as, for example, via one or more proximate mobile communication devices with a higher positioning capability. As used herein, “mobile communication device,” “wireless device,” “location-aware mobile device,” or the plural form of such terms may be used interchangeably and may refer to any kind of special purpose computing platform or apparatus that may from time to time have a position or location that changes. In some instances, a mobile communication device may, for example, be capable of communicating with one or more other devices, mobile or otherwise, through wireless transmission or receipt of information over suitable communications networks according to one or more communication protocols. As a way of illustration, special purpose mobile communication devices, which may herein be called simply mobile devices, may include, for example, cellular telephones, satellite telephones, smart telephones, personal digital assistants (PDAs), laptop computers, personal entertainment systems, tablet personal computers (PC), personal audio or video devices, personal navigation devices, or the like. It should be appreciated, however, that these are merely illustrative examples of mobile devices that may be utilized, in whole or in part, in connection with one or more operations or techniques discussed herein, and that claimed subject matter is not limited in this regard. It should also be noted that the terms “position” and “location” may be used interchangeably herein.

As alluded to previously, in an indoor environment or like partially or substantially enclosed areas (e.g., urban canyons, etc.), a mobile device may be unable to reliably receive or acquire requisite wireless signals to facilitate or support one or more position estimation techniques. As such, indoor positioning or navigation capabilities of certain mobile devices may be less useful or possibly faulty. Since, at times, satellite signals may not be reliably received or acquired in an indoor or like environment, different techniques may be employed to enable positioning or navigation services. For example, in some instances, mobile devices may obtain a position fix by determining ranges to three or more terrestrial wireless access points positioned at known locations and applying trilateration. Ranges may be determined based, at least in part, on measuring one or more characteristics of wireless signals received from these access points, such as, for example, received signal strength indicator (RSSI), round trip delay (RTT), or the like. In some instances, an estimate of a location of a mobile device may, for example, be determined in connection with one or more radio heat maps constructed for an indoor or like environment. A radio heat map may, for example, be provided in the form of observed characteristics of wireless signals indicative of expected signal strength (e.g., RSSI, etc.), round-trip delay times (e.g., RTT, etc.), or like characteristics at known locations.

Unfortunately, not all mobile devices may have inherent or built-in capabilities to estimate their locations with good or acceptable accuracy, such as, by determining ranges to known access points, measuring or comparing signal signatures, etc., for example, so as to satisfy a positioning or other application requirements, provide an adequate user experience, or the like. In some instances, one or more mobile devices may have a higher positioning capability (HPC), such as in relation to one or more other proximate mobile devices, for example. As used herein, an HPC mobile device may refer to a mobile device with a better inherent or built-in capability for estimating its location, such as in relation to one or more other mobile devices, for example, which may be characterized via a good or acceptable level of positioning accuracy under like environmental conditions (e.g., indoors, outdoors, within a particular area, floor, etc.). For example, one or more HPC mobile devices may have a better radio transmitting or receiving capability, more inherent computing resources (e.g., processing power, battery life, etc.), better access to applicable data or network, availability of pre-cached assistance data, better ranging capability (e.g., built-in RSSI and RTT receivers, wireless Wi-Fi chipset, etc.), etc. than one or more other mobile devices. Thus, in this context, these one or more other mobile devices may be referred to as having a lower positioning capability (LPC), for example.

In some instances, mobile devices with seemingly similar inherent capabilities may nevertheless have different positioning capabilities under like environmental conditions. For example, at times, certain optimizations performed on a mobile device (e.g., for a radio access network connectivity, etc.) may impair or affect in some manner its one or more positioning-related operations or functions, such as passive scans, active measurements support from an application layer, or the like. Some mobile devices may also have longer Wi-Fi scan times due, at least in part, to particularities of associated Wi-Fi drivers, as another possible example. As a way of illustration, among two proximate mobile devices, for example, with seemingly similar or like inherent capabilities (e.g., both supporting RSSI measurements, etc.), one mobile device may have a good or acceptable level of positioning accuracy (e.g., an HPC mobile device) in relation to positioning accuracy of another mobile device (e.g., an LPC mobile device) under like environmental conditions (e.g., indoors, etc.). Of course, these are merely examples relating to capabilities of HPC and LPC mobile devices, and claimed subject matter is not so limited.

Accordingly, it may be desirable to develop one or more methods, systems, or apparatuses that may enable more effective or efficient location or navigation services, such as in an indoor or like environment, for example, where wireless signals from an SPS, one or more mobile devices located outdoors, certain signal signatures, etc. are unavailable. Wireless signals may be unavailable if, for example, they are attenuated or otherwise affected in some manner, such as insufficient, weak, fragmentary, unsupported, etc., so as to preclude their use in one or more position estimation operations or processes. Thus, as will be described in greater detail below, in an implementation, an LPC mobile device located in an indoor or like environment may, for example, estimate its location based, at least in part, on one or more communication links provided by one or more proximate HPC mobile devices. For example, a presence of one or more HPC mobile devices in an indoor or like area of interest may be detected, such as via associated wireless communication links, and their respective locations may be estimated. Based, at least in part, on estimated locations, ranges to HPC mobile devices may, for example, be measured. Based, at least in part, on estimated locations and measured ranges, an indoor location of an LPC mobile device may, for example, be determined using one or more appropriate techniques, as will also be seen. As such, an LPC mobile device may be capable of obtaining a position fix in an indoor or like environment with a higher accuracy than if relied solely on the device's inherent positioning capability, for example.

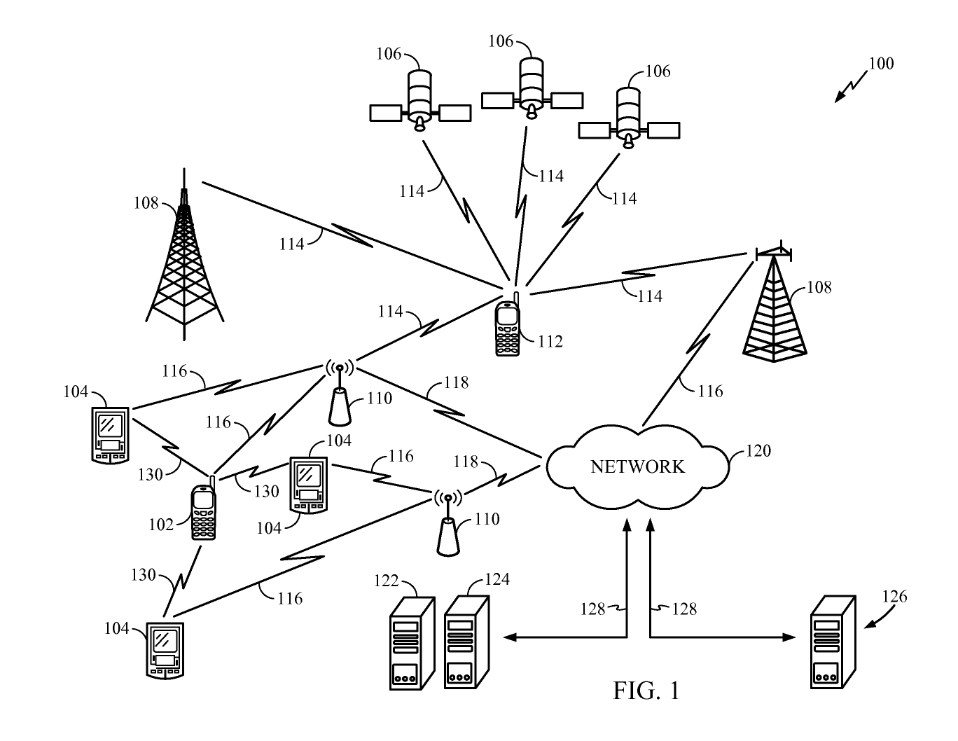

FIG. 1 is a schematic diagram illustrating features associated with an implementation of an example operating environment 100 capable of facilitating or supporting one or more processes or operations for improving positioning accuracy of an LPC mobile device, such as, mobile device 102, for example, via one or more proximate HPC mobile devices, such as mobile devices 104. It should be appreciated that operating environment 100 is described herein as a non-limiting example that may be implemented, in whole or in part, in the context of various communications networks or combination of networks, such as public networks (e.g., the Internet, the World Wide Web), private networks (e.g., intranets), wireless local area networks (WLAN, etc.), or the like. It should also be noted that claimed subject matter is not limited to indoor implementations. For example, at times, one or more operations or techniques described herein may be implemented, at least in part, in an indoor-like environment, which may include partially or substantially enclosed areas, such as urban canyons, town squares, amphitheaters, parking garages, rooftop gardens, patios, balconies, or the like. In some instances, one or more operations or techniques described herein may be implemented, at least in part, in an outdoor environment.

As illustrated, operating environment 100 may comprise, for example, one or more satellites 106, base transceiver stations 108, wireless transmitters 110, etc. that may communicate with at least one mobile device 112 located in an environment in which satellite or like wireless signals may be reliably received or acquired (e.g., outdoors, etc.). One or more satellites 106, base transceiver stations 108, wireless transmitters 110, etc. may, for example, communicate with mobile device 112 via wireless communication links 114 in accordance with one or more communication protocols. Satellites 106 may be associated with one or more satellite positioning systems (SPS), such as, for example, the United States Global Positioning System (GPS), the Russian GLONASS system, the European Galileo system, as well as any system that may utilize satellites from a combination of satellite systems, or any satellite system developed in the future. Base transceiver stations 108, wireless transmitters 110, etc. may be of the same or similar type, for example, or may represent different types of devices, such as access points, radio beacons, cellular base stations, femtocells, or the like, depending on an implementation. At times, one or more wireless transmitters, such as wireless transmitters 110, for example, may be capable of transmitting as well as receiving wireless signals.

As also illustrated, in some instances, operating environment 100 may comprise, for example, an indoor or like environment in which satellite or like wireless signals may not be reliably received or acquired (e.g., a building, shopping mall, etc.), such as by mobile devices 102 or 104, for example, located therein. Thus, to facilitate or support indoor positioning, one or more wireless signals 116 may, for example, be provided for use by these mobile devices via one or more wireless transmitters 110. As illustrated via wireless communication links 118, wireless transmitters 110 may be operatively coupled to a network 120 that may comprise, for example, one or more wired or wireless communications networks capable of providing suitable or desired information related to operating environment 100 or any portion thereof. As will be seen, provided information may comprise, for example, positioning assistance data, such as identities or locations of wireless transmitters 110, LPC mobile device 102, one or more HPC mobile devices 104, etc., last or recent position fix obtained via an SPS, suitable signaling information (e.g., RSSI, RTT, radio heat map values, etc.), map information (e.g., floor plans, etc.), or the like. Of course, claimed subject matter is not limited in these respects.

Network 120 may comprise a cellular or other wireless communications network (e.g., Wi-Fi, etc.), for example, which may provide for femtocell-based or supported operative regions of coverage, if desired. Network 120 may be capable of facilitating or supporting communications between suitable computing platforms or devices, such as, for example, mobile devices 102, 104, or 112, base transceiver stations 108, wireless transmitters 110, as well as one or more servers associated with operating environment 100. In some instances, servers may include, for example, a location server 122, positioning assistance server 124, as well as one or more other servers, indicated generally at 126 (e.g., navigation, information, map, etc. server, etc.), capable of facilitating or supporting one or more operations or processes associated with operating environment 100 via communication links 128, wireless or otherwise.

As will be described in greater detail below, location server 122 may provide to LPC mobile device 102 an estimate of a location with respect to one or more proximate mobile devices located in an indoor area of interest, such as one or more HPC mobile devices 104, for example, just to illustrate one possible implementation. If desired, positioning assistance server 124 may, for example, provide a coarse location of LPC mobile device 102 within an indoor or like area associated with operating environment 100, such as at or upon entry of an indoor or like area of interest, upon request, or the like. A coarse location may, for example, be determined based, at least in part, on last or recent position fix obtained via an SPS, input provided by an associated user (e.g., by typing an address, selecting a name, etc. of shopping mall, etc.), or other known techniques. For example, at times, a coarse location of LPC mobile device 102 may, for example, be determined using a proximity to one or more reference points, such as by knowing which wireless transmitter 110, etc. LPC mobile device 102 is using at a given time. In some instances, LPC mobile device 102 may utilize its coarse location, in whole or in part, in subsequent messages with a suitable server, such as server 126, for example, to obtain navigation, map, or other information relevant to an area identified by a coarse location (e.g., a digital map, routeability graph, etc.).

As will be discussed in greater detail below, in some instances, one or more wireless communication links 130 may be provided by or established via one or more proximate HPC mobile devices 104, for example. One or more wireless communication links 130 may, for example, be used, at least in part, by LPC mobile device 102 to detect a presence of one or more proximate HPC mobile devices 104. At times, one or more communication links 130 may comprise, for example, peer-to-peer-type communication links that may be part of a homogeneous wireless communications network, a hybrid wireless communications network, or any combination thereof. As used herein, “peer-to-peer-type communication link” may refer to one or more wireless signals that may be communicated directly between peer devices, such as, for example, without utilizing a cellular or like wireless communications network. As a way of illustration, at times, peer-to-peer-type communication link 130 may be a part of a short-range wireless communications network, such as, for example, a Bluetooth®-type network, a Home Radio Frequency (RF)-type network, a ZigBee®-type network, an infrared radiation (IR)-type network, an ultrasound identification-type network, an active Radio-Frequency Identification (RFID)-type network, an RF-type network (e.g., ultra-wide band (UWB), etc.), etc., or any combination thereof

It should be noted that even though a certain number of computing platforms or devices are illustrated herein, any number of suitable computing platforms or devices may be implemented to facilitate or otherwise support one or more techniques or processes associated with operating environment 100. For example, at times, network 120 may be coupled to one or more other wired or wireless communications networks (e.g., Wi-Fi, etc.) so as to enhance a coverage area for communications with mobile devices 102, 104, or 112, one or more base transceiver stations 108, wireless transmitters 110, servers 122, 124, 126, or the like. In some instances, network 120 or one or more coupled wired or wireless communications networks may, for example, facilitate or support femtocell-based operative regions of coverage, as previously mentioned. Again, these are merely illustrative examples relating to operating environment 100, and claimed subject matter is not limited in this regard.

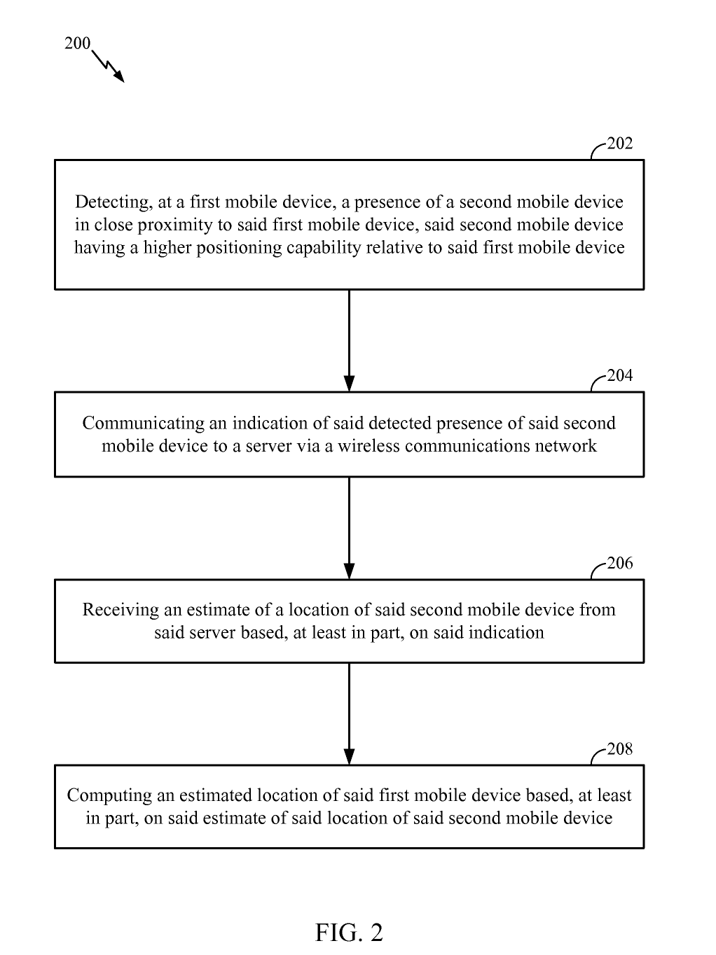

With this in mind, attention is now drawn to FIG. 2, which is a flow diagram illustrating a summary of an implementation of an example process 200 that may be performed, in whole or in part, to facilitate or support one or more operations or techniques for improving positioning accuracy of an LPC mobile device, such as mobile device 102 of FIG. 1, for example, via at least one proximate HPC mobile device, such as mobile device 104 of FIG. 1, for example. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 200 may, for example, begin at operation 202 with detecting, at a first mobile device, a presence of a second mobile device located in close proximity to the first mobile device, the second mobile device having a higher positioning capability (e.g., an HPC mobile device) relative to the first mobile device (e.g., an LPC mobile device). As previously discussed, if desired, at or upon entry of an indoor or like area of interest, a first mobile device may, for example, determine its coarse location using one or more appropriate techniques. A first mobile device may, for example, determine its coarse location on its own or via communications with a suitable server (e.g., positioning assistance server 124 of FIG. 1, etc.). A presence of a second mobile device, such as in an indoor or like area identified by the coarse location, for example, may be detected via a wireless communication link provided by the second mobile device (e.g., link 130 of FIG. 1, etc.) that a first mobile device may be capable of sensing due, at least in part, to its close proximity. At times, a provided link may comprise, for example, a peer-to-peer-type wireless communication link that may be a part of a short-range wireless communications network.

Depending on an implementation, a short-range wireless communications network may comprise, for example, a homogeneous wireless communications network, a hybrid wireless communications network, or any combination thereof. As used herein, “homogeneous wireless communications network” may refer to a type of a network capable of supporting the same or similar communication modality (e.g., bandwidth, spread spectrum, frequency, type of communication, duty cycle, etc.), and “hybrid wireless communications network” may refer to a type of a network capable of supporting different communication modalities. As a way of illustration, a short-range wireless communications network may comprise, for example, a Bluetooth®-type network, a Home Radio Frequency (RF)-type network, a ZigBee®-type network, an infrared radiation (IR)-type network, an ultrasound identification-type network, an active Radio-Frequency Identification (RFID)-type network, an RF-type network (e.g., UWB, etc.), etc., or any combination thereof. Of course, these are merely examples relating to short-range wireless communications networks that may be utilized, at least in part, in connection with operation 202, and claimed subject matter is not so limited.

At operation 204, an indication of a detected presence of a second mobile device (e.g., an HPC mobile device), such as in an indoor or like area identified via a coarse location of a first mobile device, for example, may be communicated to a suitable server (e.g., location server 122, positioning assistance server 124, etc. of FIG. 1), such as via a wireless communications network. As previously mentioned, in some instances, a wireless communications network may be associated with an indoor or like environment and may comprise any suitable network, such as a Wi-Fi-type network, for example (e.g., a wireless local area network (WLAN), etc.), just to illustrate one possible implementation. An indication of a detected presence of a second mobile device may include, for example, an associated media access control (MAC) address, a network access ID, a mobile ID number, a wireless carrier subscription number, mobile device identification information, etc., or any combination thereof. Claimed subject matter is not limited to these particular indications, of course. Any other suitable indication of a detected presence of a second mobile device may be utilized, in whole or in part.

With regard to operation 206, an estimate of a location of a second mobile device (e.g., an HPC mobile device) may be received, such as by a first mobile device (e.g., an LPC mobile device), for example, from a suitable server (e.g., location server 122, positioning assistance server 124, etc. of FIG. 1) based, at least in part, on an indication of a detected presence of the second mobile device. According to an implementation, having received an indication, a suitable server may, for example, estimate a location of a second mobile device within an indoor or like area of interest identified via such an indication using one or more appropriate techniques. For example, an estimate of an indoor location of a second mobile device may be determined, at least in part, by measuring ranges from the device to three or more terrestrial wireless access points positioned at known locations within an area identified by a coarse location of a first mobile device (e.g., wireless transmitters 110 of FIG. 1, etc.) and applying trilateration. At times, a location of a second mobile device may be estimated, at least in part, via radio heat map signature matching, for example, by comparing expected and previously measured signal characteristics stored as heat map values in an appropriate database (e.g., server 124 of FIG. 1, etc.). It should be noted that any other suitable indoor positioning techniques (e.g., cell identification (Cell-ID), cell of origin (COO), etc.) may be employed, in whole or in part. In some instances, a location of a second mobile device may be estimated on or by the device itself, such as using one or more techniques discussed above, for example, and may be subsequently communicated to a suitable server, just to illustrate another possible implementation. Here, one or more mobile device-server communications may, for example, be implemented via a wireless communications network (e.g., Wi-Fi, WLAN, etc.) of an indoor or like area of interest.

At operation 208, an estimated location of a first mobile device (e.g., an LPC mobile device) may, for example, be computed based, at least in part, on an estimate of a location of a second mobile device (e.g., an HPC mobile device). For example, in some instances, such as if an estimated location of a second mobile device is determined to be in a sufficiently close proximity to a location of a first mobile device, the estimated location of the second mobile device may be considered as an estimated location of the first mobile device (e.g., first and second mobile devices considered to be co-located, etc.). At times, a proximity of a first mobile device to a second mobile device may, for example, be computed using a strength of a signal received by or at the first mobile device, such as via a detected wireless communication link (e.g., link 130 of FIG. 1, etc.). By way of example but not limitation, a second mobile device may, for example, be considered to be co-located with a first mobile device if a received signal strength indicates that a distance between the devices is 5.0 meters or less. Claimed subject matter is not so limited, of course. In some instances, such as if more than one peer-to-peer-type wireless communication links are detected, a first mobile device may be considered to be co-located with an HPC mobile device that provides a stronger signal or a signal indicative of a shorter distance or range, for example.

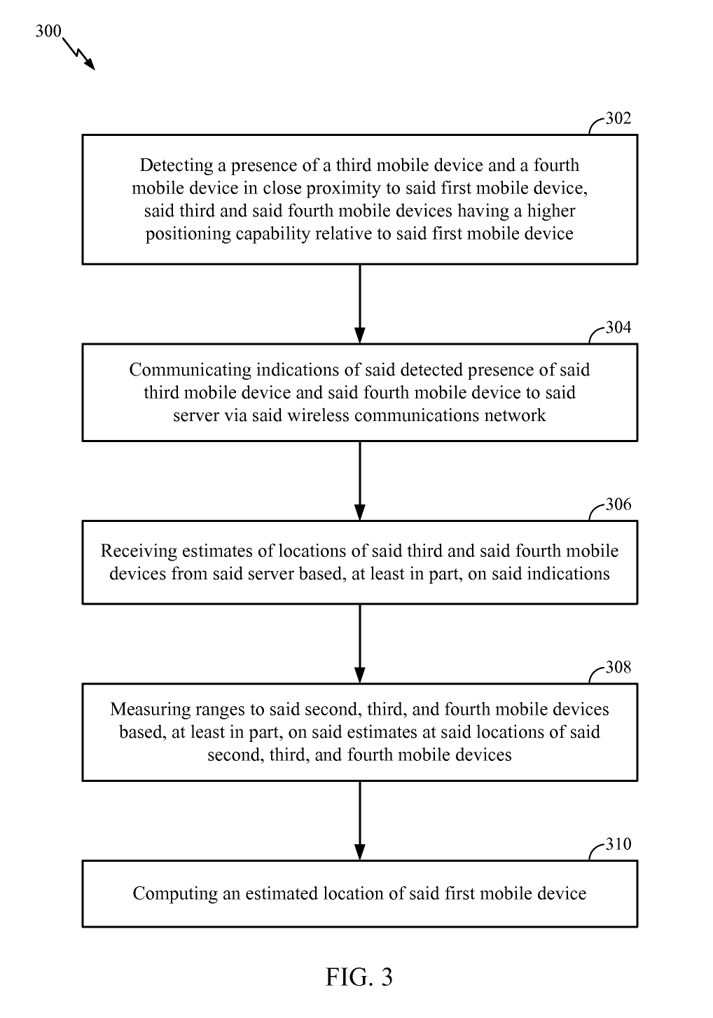

FIG. 3 is a flow diagram illustrating aspects of an implementation of an example process 300 that may be performed, in whole or in part, to improve positioning accuracy of an LPC mobile device (e.g., LPC mobile device 102 of FIG. 1, etc.), such as if three or more proximate HPC mobile devices (e.g., HPC mobile devices 104 of FIG. 1, etc.) are detected, for example. In some instances, process 300 may be performed, for example, in addition to one or more operations of process 200 of FIG. 2. Again, here, information acquired or produced, such as, for example, input signals, output signals, operations, results, etc. associated with example process 300 may be represented via one or more digital signals. Likewise, even though one or more operations are illustrated or described concurrently or with respect to a certain sequence, other sequences or concurrent operations may be employed. Also, the description below may reference particular aspects or features illustrated in certain other figures, for example, and one or more operations may be performed with other aspects or features.

At operation 302, a presence of a third mobile device and a fourth mobile device, such as in addition to the presence of the second mobile device discussed above, for example, located in close proximity to a first mobile device may be detected. Likewise, here, a third mobile device and a fourth mobile device may, for example, have a higher positioning capability (e.g., HPC mobile devices) relative to a first mobile device (e.g., an LPC mobile device). Similarly to operation 202 discussed above, a presence of a third mobile device and a fourth mobile device may, for example, be detected via associated wireless communication links provided by these devices (e.g., links 130 of FIG. 1, etc.). Likewise, links may comprise, for example, peer-to-peer-type wireless communication links that may be a part of a short-range wireless communications network (e.g., homogeneous, hybrid, etc.).

With regard to operation 304, indications of a detected presence of a third mobile device and a fourth mobile device (e.g., HPC mobile devices) may, for example, be communicated to a suitable server (e.g., location server 122, positioning assistance server 124, etc. of FIG. 1), such as via a wireless communications network. These indications may, for example, be communicated in addition to the indication of the detected presence of the second mobile device of FIG. 2, such as discussed above. Likewise, here, indications may comprise, for example, respective media access control (MAC) addresses, network access IDs, mobile ID numbers, wireless carrier subscription numbers, mobile devices identification information, etc., or any combination thereof.

At operation 306, estimates of locations of a third and a fourth mobile devices may be received, such as in addition to the estimate of the location of the second mobile device of FIG. 2, for example, from a suitable server (e.g., location server 122, positioning assistance server 124, etc. of FIG. 1) based, at least in part, on such indications. Here, estimates of locations of a third and a fourth mobile devices, such as within an indoor or like area of interest, for example, may be determined using one or more techniques discussed above in connection with operation 206 (e.g., trilateration, radio heat map signature matching, Cell-ID, COO, etc.). Likewise, here, estimates of locations of a third and a fourth mobile devices may, for example, be determined on or by a suitable server, mobile devices themselves, or any combination thereof, depending on an implementation. Estimates of respective locations may be communicated, such as to a first mobile device, for example, via a wireless communications network (e.g., Wi-Fi, etc.), which, in some instances, may be associated with an indoor or like area of interest, as was also discussed.

At operation 308, ranges to a second, third, and fourth mobile devices may, for example, be measured based, at least in part, on received estimates of locations of the second, third, and fourth mobile devices. Ranges may be measured using any suitable techniques (e.g., received signal strength, etc.). In some instances, a type of a network of short-range peer-to-peer-type wireless communication links provided by a second, third, and fourth mobile devices (e.g., a Bluetooth®-type network, ZigBee®-type network, etc.) may, for example, be suggestive of ranges separating a first mobile device from these mobile devices. By way of example but not limitation, in certain simulations or experiments, it has been observed that a Bluetooth®-type network may offer or provide a relatively shorter operational range than, for example, a ZigBee®-type or Home RF-type network. As such, in some instances, respective signal power levels received by or at a first mobile device may be converted to distance estimates or ranges using any suitable technique that may account for operative ranges of associated networks. For example, at times, received signal power levels may be converted to distance estimates or ranges according to a simple propagation model, and distance estimates or ranges may be dynamically adjusted on the basis of operative ranges of detected networks. Claimed subject matter is not limited to such an observation, networks, or distance estimates, of course.

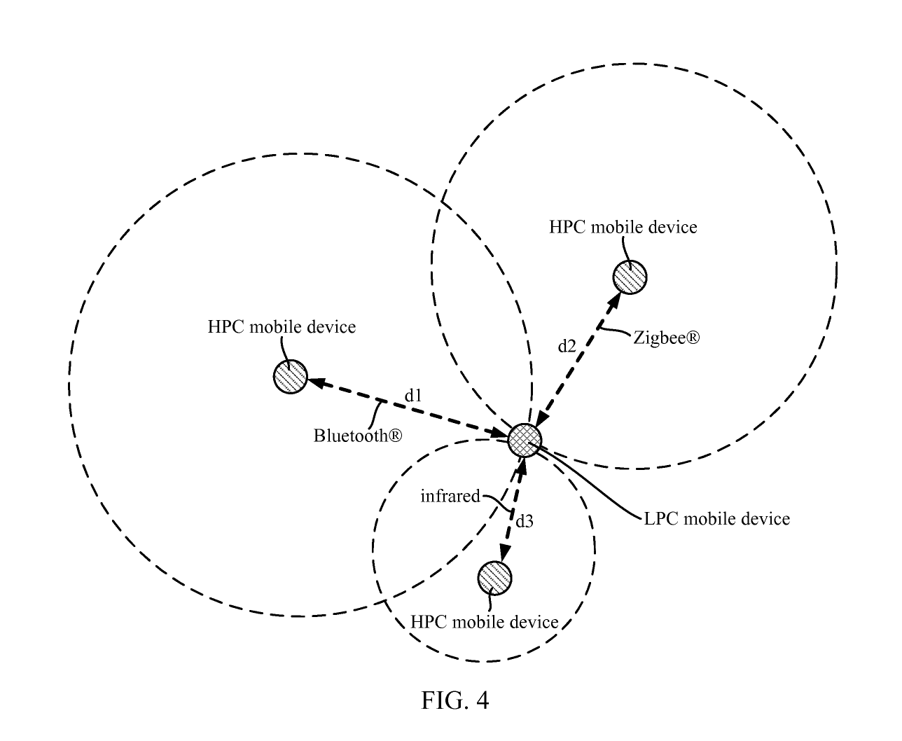

At operation 310, an estimated location of a first mobile device may, for example, be computed. For example, such an estimated location may be computed by performing a trilateration operation based, at least in part, on received estimates of locations of a second, third, and fourth mobile devices and respective measured ranges to same, just to illustrate one possible implementation. By way of example, as seen in FIG. 4, with knowledge of estimates of locations of a second, third, and fourth mobile devices (e.g., HPC mobile devices) and measurements of ranges d1, d2, and d3 obtained via respective peer-to-peer-type wireless communication links (e.g., Bluetooth®, ZigBee®, IR, etc.), an estimated location of an LPC mobile device may be computed via trilateration. In some instances, an indoor location of a first mobile device may, for example, be estimated by computing a centroid of a region or area defined by respective estimated locations of a second, third, and fourth mobile devices, as another possible implementation. Again, these are merely examples to which claimed subject matter is not limited.

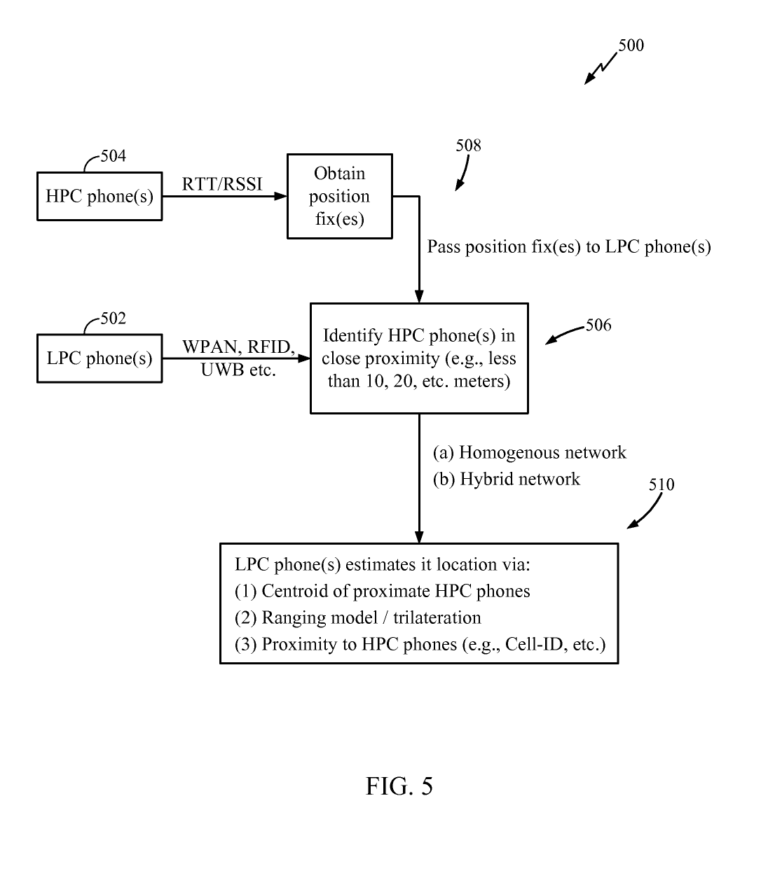

FIG. 5 is a flow diagram of an implementation of a process 500 illustrating an example use case or scenario of improving positioning accuracy of an LPC cellular phone 502 located indoors (e.g., in a shopping mall, etc.), such as, for example, via one or more proximate HPC cellular phones 504. As alluded to previously, mobile devices 502 or 504 may, for example, subscribe to service from the same wireless carrier, different wireless carriers, or any combination thereof. Mobile devices 502 or 504 may also subscribe to the same indoor location service, for example, or different indoor location services, which may depend on an implementation, mobile device, service, or the like.

As referenced via an arrow at 506, at or upon turning on, rebooting, entering an indoor or like area of interest, etc., LPC phone 502 may, for example, detect one or more HPC phones located in close proximity to LPC phone 502 (e.g., within 10, 15, 20, etc. meters), such as via a number of associated WPAN, active RFID, UWB, or like peer-to-peer-type wireless communication links, as discussed above. For example, in some instances, LPC phone 502 may detect wireless communication links from one or more HPC phones without broadcasting a query seeking locations of these mobile devices. As was also indicated, if desired, LPC phone 502 may, for example, determine its coarse location based, at least in part, on a recent position fix obtained via an SPS, proximity to one or more wireless transmitters (e.g., Wi-Fi access points, etc.), messages received from a suitable server (e.g., a location, positioning assistance, etc. server), via a user input, or the like.

As indicated at 508, one or more proximate HPC phones 504 may, for example, obtain their respective position fixes within an area identified by a coarse location of LPC phone 502, such as via one or more approaches discussed above (e.g., via RTT, RSSI, etc.), and may pass or communicate these position fixes to LPC phone 502 in a suitable manner (e.g., via a Wi-Fi network, location server, etc.). Optionally or alternatively, one or more position fixes of respective HPC phones 504 may, for example, be obtained without determining a coarse location of LPC phone 502. As illustrated at 510, LPC phone 502 may estimate its location, such as using distances or ranges to one or more detected HPC phones 504 and their respective position fixes, for example, via one or more appropriate techniques. As was indicated, in some instances, respective distances or ranges to one or more HPC phones 504 may, for example, be measured based, at least in part, on a type of a network of short-range peer-to-peer-type wireless communication links provided by HPC phones 504.

As illustrated, a location of LPC phone 502 may, for example, be estimated, at least in part, via computing a centroid of respective position fixes of proximate HPC phones 504, via utilizing a ranging and trilateration model or approach discussed above, via proximity to one or more HPC phones (e.g., Cell-ID, COO, etc.), or the like. Accordingly, here, LPC phone 502 may be capable of estimating its location in an indoor or like environment with a higher accuracy than if relied solely on the phone's inherent positioning capability, for example. In some instances, such as if LPC phone 502 continues to travel or navigate within an indoor or like environment, for example, a position of the phone may be updated in any suitable manner (e.g., continually, periodically, etc.). For example, at times, a position of LPC phone 502 may be updated dynamically, such as via one or more operations or techniques discussed above, whenever LPC phone 502 detects or encounters a sufficient number of wireless communication links provided by proximate HPC devices 504. Of course, a description of certain aspects of process 500 is merely an example, and claimed subject matter is not so limited.

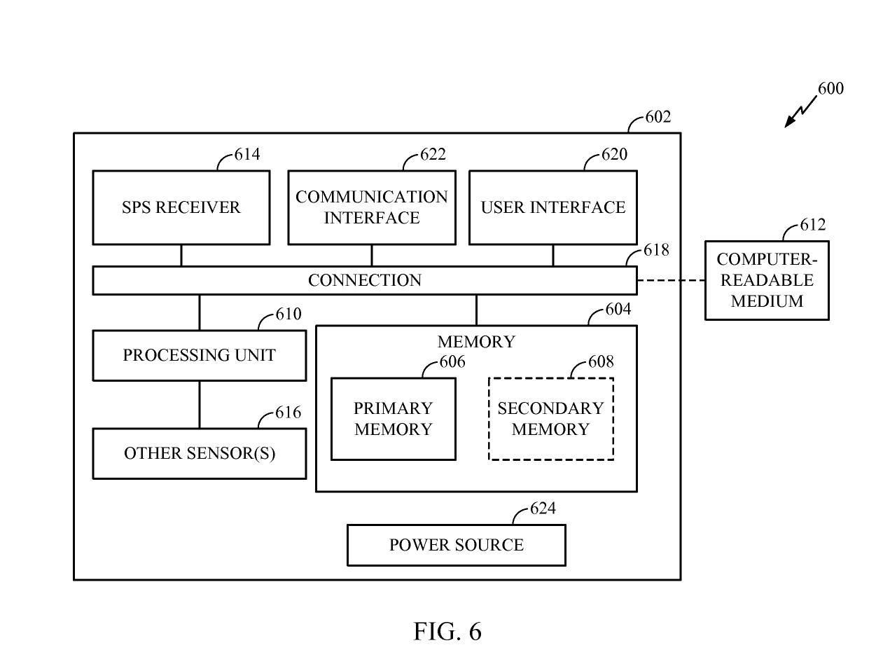

FIG. 6 is a schematic diagram illustrating an implementation of an example computing environment 600 that may include one or more mobile devices capable of partially or substantially implementing or supporting one or more operations or processes for improving positioning accuracy of an LPC mobile device, such as, for example, via one or more proximate HPC mobile devices. It should be appreciated that all or part of various devices shown in computing environment 600, processes, or methods, as described herein, may be implemented using various hardware, firmware, or any combination thereof along with software.

Example computing environment 600 may comprise, for example, a mobile device 602 that may include one or more features or aspects of LPC mobile device 102 or HPC mobile device 104 of FIG. 1, though claimed subject matter is not so limited. For example, mobile device 602 may be capable of communicating with one or more other devices, mobile or otherwise, via a cellular telephone network, the Internet, mobile ad-hoc network, wireless sensor network (e.g., homogeneous, hybrid, etc.), Wi-Fi-type network (e.g., WPAN, etc.), or the like. In an implementation, mobile device 602 may be representative of any electronic or computing device, machine, appliance, or platform that may be capable of exchanging information over any suitable network. For example, mobile device 602 may include one or more computing devices or platforms associated with, for example, cellular telephones, satellite telephones, smart telephones, personal digital assistants (PDAs), laptop computers, personal entertainment systems, e-book readers, tablet personal computers (PC), personal audio or video devices, personal navigation devices, or the like. In certain example implementations, mobile device 602 may take the form of one or more integrated circuits, circuit boards, or the like that may be operatively enabled for use in another device. Thus, unless stated otherwise, to simplify discussion, various functionalities, elements, components, etc. are described below with reference to mobile device 602 may also be applicable to other devices not shown so as to support one or more processes associated with example computing environment 600.

Although not shown, optionally or alternatively, there may be additional devices, mobile or otherwise, communicatively coupled to mobile device 602 to facilitate or otherwise support one or more processes associated with computing environment 600, such as discussed above. For example, computing environment 600 may include various computing or communication resources or devices capable of obtaining all or part of position or location parameters with regard to mobile device 602, applicable indications of detected presence of one or more mobile devices, etc. based, at least in part, on one or more wireless signals associated with a positioning system, location-based service, wireless communications network, or the like. Location parameters may, for example, be stored in some manner in memory 604 along with other suitable or desired parameters, such as measured ranges, aspects or modalities of cellular or peer-to-peer-type wireless communications networks, or the like.

Memory 604 may represent any suitable information storage medium. For example, memory 604 may include a primary memory 606 and a secondary memory 608. Primary memory 606 may include, for example, a random access memory, read only memory, etc. While illustrated in this example as being separate from a processing unit 610, it should be appreciated that all or part of primary memory 606 may be provided within or otherwise co-located/coupled with processing unit 610. Secondary memory 608 may include, for example, the same or similar type of memory as primary memory or one or more information storage devices or systems, such as, for example, a disk drive, an optical disc drive, a tape drive, a solid state memory drive, etc. In certain implementations, secondary memory 608 may be operatively receptive of, or otherwise enabled to be coupled to, a computer-readable medium 612.

Computer-readable medium 612 may include, for example, any medium that may store or provide access to information, code or instructions (e.g., an article of manufacture, etc.) for one or more devices associated with computing environment 600. For example, computer-readable medium 612 may be provided or accessed by processing unit 610. As such, in certain example implementations, the methods or apparatuses may take the form, in whole or part, of a computer-readable medium that may include computer-implementable instructions stored thereon, which may be executed by at least one processing unit or other like circuitry so as to enable processing unit 610 or the other like circuitry to perform all or portions of a location determination processes (e.g., GPS position fix processes, indoor position fix processes, etc.), or any processes to facilitate or support one or more operations or techniques discussed herein. In certain example implementations, processing unit 610 may be capable of performing or supporting other functions, such as wireless communications, navigations, video gaming, or the like.

It should be understood that a storage medium, such as memory 604, computer-readable medium 612, etc. may typically, although not necessarily, be non-transitory or may comprise a non-transitory device. In this context, a non-transitory storage medium may include, for example, a device that is physical or tangible, meaning that the device has a concrete physical form, although the device may change state. For example, one or more electrical binary digital signals representative of information, in whole or in part, in the form of zeros may change a state to represent information, in whole or in part, as binary digital electrical signals in the form of ones, to illustrate one possible implementation. As such, “non-transitory” may refer, for example, to any medium or device remaining tangible despite this change in state.

Processing unit 610 may be implemented in hardware or a combination of hardware and software. Processing unit 610 may be representative of one or more circuits capable of performing at least a portion of information computing technique or process. By way of example but not limitation, processing unit 610 may include one or more processors, controllers, microprocessors, microcontrollers, application specific integrated circuits, digital signal processors, programmable logic devices, field programmable gate arrays, or the like, or any combination thereof. Thus, at times, processing unit 610 may comprise, for example, or be representative of means for detecting, at a first mobile device, a presence of a second mobile device located in an indoor environment and in close proximity to the first mobile device, the second mobile device having a higher positioning capability relative to the first mobile device, means for communicating an indication of the detected presence of the second mobile device to a location server via a wireless communications network of the indoor environment, means for receiving an estimate of a location of the second mobile device from the location server based, at least in part, on the indication, and means for computing an estimated location of the first mobile device based, at least in part, on the estimate of the location of the second mobile device.

In some instances, processing unit 610 may also comprise, for example, or be representative of means for detecting a presence of a third mobile device and a fourth mobile device located in the indoor environment and in close proximity to the first mobile device, the third and the fourth mobile devices having a higher positioning capability relative to the first mobile device, means for communicating indications of the detected presence of the third mobile device and the fourth mobile device to the location server via the wireless communications network of the indoor environment, means for receiving estimates of locations of the third and the fourth mobile devices from the location server based, at least in part, on the indications, and means for measuring ranges to the second, third, and fourth mobile devices based, at least in part, on the estimates of the locations of the second, third, and fourth mobile devices. Depending on an implementation, processing unit 610 may also comprise, for example, or be representative of means for computing an estimated location of the first mobile device, such as via one or more suitable techniques.

Mobile device 602 may include various sensors, components, or circuitry, such as, for example, an SPS receiver 614 capable of acquiring wireless signals from a satellite positioning system (SPS), such as the global positioning system (GPS) or other like Global Navigation Satellite System (GNSS), cellular base station, location beacon, or the like. Although not shown, mobile device 602 may include a location-tracking unit that may obtain a position fix of mobile device 602, for example, based, at least in part, on one or more received or acquired wireless signals, such as from an SPS, a mobile device located outdoors, a mobile device located indoors, a wireless transmitter, or the like. In some implementations, a location-tracking unit may be at least partially integrated with a suitable processing unit, such as processing unit 610, for example, though claimed subject matter is not so limited. Mobile device 602 may include one or more other sensors 616, such as, for example, an RF or like receiver capable of detecting one or more peer-to-peer-type wireless communication links, signal signatures, wireless signals, etc., an accelerometer, magnetometer, ambient light detector, camera imager, microphone, temperature sensor, atmospheric pressure sensor, etc. to facilitate or otherwise support one or more processes associated with computing environment 600. For example, sensors may provide analog or digital signals to processing unit 610. Although not shown, it should be noted that mobile device 602 may include an analog-to-digital converter (ADC) for digitizing analog signals from one or more sensors. Optionally or alternatively, such sensors may include a designated (e.g., an internal, etc.) ADC(s) to digitize signals, although claimed subject matter is not so limited.

Mobile device 602 may include one or more connections 618 (e.g., buses, lines, conductors, optic fibers, etc.) to operatively couple various circuits together, and a user interface 620 (e.g., display, touch screen, keypad, buttons, knobs, microphone, speaker, trackball, information port, etc.) to receive user input, facilitate or support positioning, provide information to a user, or the like. Mobile device 602 may further include a communication interface 622 (e.g., wireless transmitter or receiver, modem, antenna, etc.) to allow for communication with one or more other devices or systems over one or more suitable communications networks, as was also indicated.

In an implementation, mobile device 602 may include a power source 624 to provide power to some or all of the sensors, components, or circuitry. Power source 624 may be a portable power source, such as a battery, for example, or may comprise a fixed power source, such as an outlet (e.g. in a house, electric charging station, car, etc.). It should be appreciated that power source 624 may be integrated into (e.g., built-in, etc.) or otherwise supported by (e.g., stand-alone, etc.) mobile device 602. Although not shown, mobile device 602 may also include a memory or information buffer to collect suitable or desired information, such as, for example, one or more radio heat map values, range measurements, a history of GPS position fixes, indications of a detected presence, user or network-related attributes or modalities, or the like.

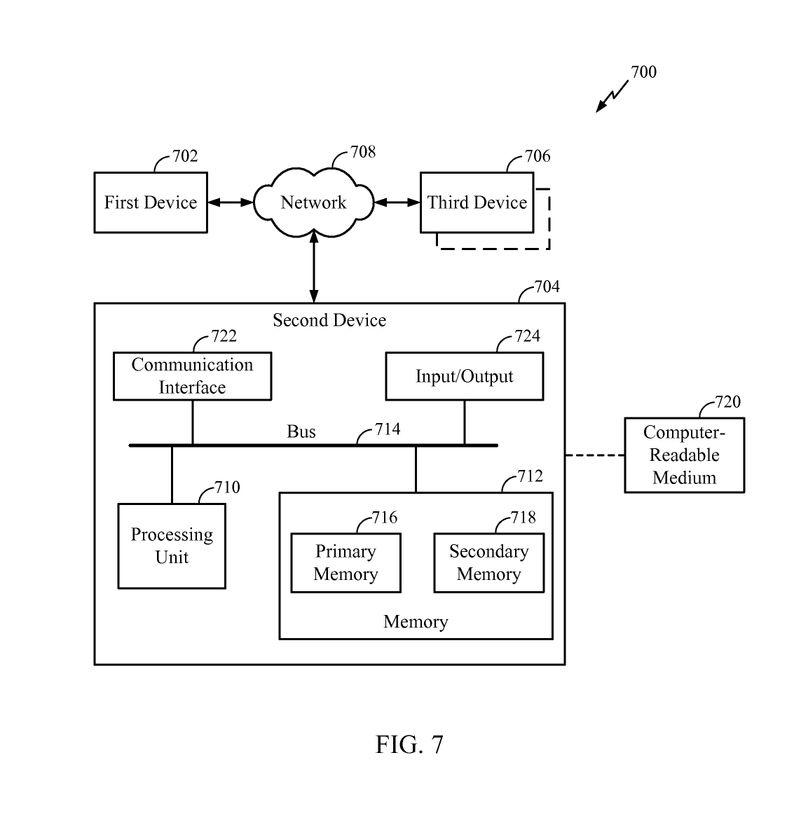

FIG. 7 is a schematic diagram illustrating an implementation of an example computing environment 700 that may include one or more servers or other devices capable of partially or substantially implementing or supporting one or more operations or processes for improving positioning accuracy of an LPC mobile device, such as via one or more proximate HPC mobile devices, for example, as discussed above in connection with FIGS. 1-5. Computing environment 700 may include, for example, a first device 702, a second device 704, a third device 706, etc., which may be operatively coupled together via a communications network 708.

First device 702, second device 704, or third device 706 may be representative of any device, appliance, platform, or machine that may be capable of exchanging information over communications network 708. By way of example but not limitation, any of first device 702, second device 704, or third device 706 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 702, 704, and 706, respectively, may comprise one or more of a mobile device, wireless transmitter or receiver, server, etc. in accordance with example implementations described herein.

In an implementation, communications network 708 may be representative of one or more communication links, processes, or resources capable of supporting an exchange of information between at least two of first device 702, second device 704, or third device 706. By way of example but not limitation, communications network 708 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 706, there may be additional like devices operatively coupled to communications network 708. It is also recognized that all or part of various devices or networks shown in computing environment 700, or processes or methods, as described herein, may be implemented using or otherwise including hardware, firmware, software, or any combination thereof.

By way of example but not limitation, second device 704 may include at least one processing unit 710 that may be operatively coupled to a memory 712 via a bus 714. Processing unit 710 may be representative of one or more circuits capable of performing at least a portion of a suitable computing procedure or process. For example, processing unit 710 may include one or more processors, controllers, microprocessors, microcontrollers, application specific integrated circuits, digital signal processors, programmable logic devices, field programmable gate arrays, or the like, or any combination thereof. Although not shown, second device 704 may include a location-tracking unit that may initiate a coarse position fix of a mobile device of interest, such as in an indoor or like area of interest, for example, based, at least in part, on one or more recently received or acquired wireless signals, such as from an SPS. In some implementations, a location-tracking unit may be at least partially integrated with a suitable processing unit, such as processing unit 710, for example, though claimed subject matter is not so limited. In certain server-based or server-supported implementations, processing unit 710 may, for example, comprise facilitating or supporting means for detecting, at a first mobile device, a presence of a second mobile device located in an indoor environment and in close proximity to the first mobile device, the second mobile device having a higher positioning capability relative to the first mobile device, means for communicating an indication of the detected presence of the second mobile device to a location server via a wireless communications network of the indoor environment, means for receiving an estimate of a location of the second mobile device from the location server based, at least in part, on the indication, and means for computing an estimated location of the first mobile device based, at least in part, on the estimate of the location of the second mobile device.

In some instances, processing unit 710 may also comprise, for example, facilitating or supporting means for detecting a presence of a third mobile device and a fourth mobile device located in the indoor environment and in close proximity to the first mobile device, the third and the fourth mobile devices having a higher positioning capability relative to the first mobile device, means for communicating indications of the detected presence of the third mobile device and the fourth mobile device to the location server via the wireless communications network of the indoor environment, means for receiving estimates of locations of the third and the fourth mobile devices from the location server based, at least in part, on the indications, and means for measuring ranges to the second, third, and fourth mobile devices based, at least in part, on the estimates of the locations of the second, third, and fourth mobile devices. Depending on an implementation, processing unit 710 may also comprise, for example, facilitating or supporting means for computing an estimated location of the first mobile device, such as via one or more suitable techniques.

Memory 712 may be representative of any information storage mechanism or appliance. Memory 712 may include, for example, a primary memory 716 and a secondary memory 718. Primary memory 716 may include, for example, a random access memory, read only memory, etc. While illustrated in this example as being separate from processing unit 710, it should be understood that all or part of primary memory 716 may be provided within or otherwise co-located/coupled with processing unit 710. Secondary memory 718 may include, for example, same or similar type of memory as primary memory or one or more information storage devices or systems, such as, for example, a disk drive, an optical disc drive, a tape drive, a solid state memory drive, etc. In certain implementations, secondary memory 718 may be operatively receptive of, or otherwise configurable to couple to, a computer-readable medium 720. Computer-readable medium 720 may include, for example, any non-transitory storage medium that may carry or make accessible information, code, or instructions for one or more of devices in computing environment 700. Computer-readable medium 720 may also be referred to as a storage medium.

Second device 704 may include, for example, a communication interface 722 that may provide for or otherwise support an operative coupling of second device 704 to at least communications network 708. By way of example but not limitation, communication interface 722 may include a network interface device or card, a modem, a router, a switch, a transceiver, and the like. Second device 704 may also include, for example, an input/output device 724. Input/output device 724 may be representative of one or more devices or features that may be configurable to accept or otherwise introduce human or machine inputs, or one or more devices or features that may be capable of delivering or otherwise providing for human or machine outputs. By way of example but not limitation, input/output device 724 may include an operatively configured display, speaker, keyboard, mouse, trackball, touch screen, information port, or the like.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform functions described herein. Any machine readable medium tangibly embodying instructions may be used in implementing methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of information as expressed by a particular state of the storage media. For example, an electronic signal representative of information may be “stored” in a portion of the storage media (e.g., memory) by affecting or changing the state of such portions of the storage media to represent information as binary information (e.g., via ones and zeros). As such, in a particular implementation, such a change of state of the portion of the storage media to store a signal representative of information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to store desired program code in the form of instructions or information structures and that may be accessed by a computer or processor thereof. Disk and disc, as used herein, includes compact disc (CD), laser disc, optical disc, digital versatile disc (DVD), floppy disk and blue-ray disc where disks usually reproduce information magnetically, while discs reproduce information optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN), a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In an implementation, a mobile device may, for example, be capable of communicating with one or more femtocells, such as for the purpose of estimating its location, communicating with a suitable server, or the like. As used herein, “femtocell” may refer to one or more smaller-size cellular base stations that may be capable of detecting a wireless signal transmitted from a mobile device using one or more appropriate techniques. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated Wi-Fi, for example. However, such details relating to femtocells are merely examples, and claimed subject matter is not so limited.

Also, if applicable, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
detecting, at a first mobile device, a presence of a second mobile device in close proximity to said first mobile device, said second mobile device having a higher positioning capability relative to said first mobile device;
communicating an indication of said detected presence of said second mobile device to a server via a wireless communications network;
receiving an estimate of a location of said second mobile device from said server based, at least in part, on said indication; and
computing an estimated location of said first mobile device based, at least in part, on said estimate of said location of said second mobile device.

2. The method of claim 1, and further comprising:
detecting a presence of a third mobile device and a fourth mobile device in close proximity to said first mobile device, said third and said fourth mobile devices having a higher positioning capability relative to said first mobile device;
communicating indications of said detected presence of said third mobile device and said fourth mobile device to said server via said wireless communications network;
receiving estimates of locations of said third and said fourth mobile devices from said server based, at least in part, on said indications; and
measuring ranges to said second, third, and fourth mobile devices based, at least in part, on said estimates of said locations of said second, third, and fourth mobile devices.

3. The method of claim 2, and further comprising computing an estimated location of said first mobile device via performing at least one of the following: a trilateration operation based, at least in part, on said received estimates of locations of said second, third, and said fourth mobile devices and said ranges; a computation of a centroid based, at least in part, on said received estimates of locations of said second, third, and said fourth mobile devices and said ranges; or any combination thereof.

4. The method of claim 2, and further comprising:
receiving a coarse location of said first mobile device from said server via said wireless communications network, said coarse location of said first mobile device being determined via at least one of the following: a recent position fix obtained via an SPS; a proximity to one or more wireless transmitters; a user input; or any combination thereof.

5. The method of claim 2, wherein said detecting said presence of said second, third, and fourth mobile devices comprises detecting one or more peer-to-peer-type wireless communication links provided by said second, third, and fourth mobile devices.

6. The method of claim 5, wherein said detecting said one or more peer-to-peer-type wireless communication links comprises detecting said one or more links without broadcasting a query by said first mobile device to seek locations of said second, third, and fourth mobile devices.

7. The method of claim 5, wherein said one or more peer-to-peer-type wireless communication links are part of a short-range wireless communications network.

8. The method of claim 7, wherein said short-range wireless communications network comprises at least one of the following: a homogeneous wireless communications network; a hybrid wireless communications network; or any combination thereof.

9. The method of claim 7, wherein said short-range wireless communications network comprises at least one of the following: a Bluetooth®-type network; a Home Radio Frequency (RF)-type network; a ZigBee®-type network; an infrared radiation (IR)-type network; an ultrasound identification-type network; an active Radio-Frequency Identification (RFID)-type network; an RF-type network; or any combination thereof.

10. The method of claim 2, wherein said detecting said presence of said second, third, and fourth mobile devices is based, at least in part, on processing one or more wireless signals received from said server via said wireless communications network.

11. The method of claim 2, wherein said indications of said detected presence of said second, third, and fourth mobile devices comprise at least one of the following: a media access control (MAC) address; a network access ID; a mobile ID number; a wireless carrier subscription number; mobile device identification information; or any combination thereof.

12. The method of claim 1, wherein said wireless communications network comprises at least one of the following: a homogeneous wireless communications network; a hybrid wireless communications network; or any combination thereof.

13. The method of claim 1, wherein said wireless communications network comprises a WiFi-type network.

14. The method of claim 1, wherein said wireless communications network is associated with an indoor environment.

15. The method of claim 14, wherein said indoor environment comprises an environment where wireless signals from a satellite positioning system (SPS) are unavailable.

16. The method of claim 2, wherein said locations of said second, third, and fourth mobile devices are estimated based, at least in part, on at least one of the following: a received signal strength indicator (RSSI); a round-trip delay time (RTT); or any combination thereof.

17. The method of claim 2, wherein said first, second, third, and fourth mobile devices subscribe to service from at least one of the following: the same wireless carrier; different wireless carriers; or any combination thereof.

18. The method of claim 2, wherein said first, second, third, and fourth mobile devices subscribe to at least one of the following: the same indoor location service; different indoor location services; or any combination thereof.

19. The method of claim 2, wherein said ranges are measured based, at least in part, a type of a network of short-range peer-to-peer-type wireless communication links provided by said second, third, and fourth mobile devices.

20. The method of claim 2, wherein said first, second, third, and fourth mobile devices are located in an indoor environment.

21. The method of claim 1, wherein said server comprises at least one of the following: a location server; a positioning assistance server; a navigation server; an information server; a map server; or any combination thereof.

22. An apparatus comprising:
a communication interface; and
at least one processor programmed with instructions to:
detect, at a first mobile device, a presence of a second mobile device in close proximity to said first mobile device, said second mobile device having a higher positioning capability relative to said first mobile device;
communicate an indication of said detected presence of said second mobile device to a server via a wireless communications network;
receive an estimate of a location of said second mobile device from said server based, at least in part, on said indication; and
compute an estimated location of said first mobile device based, at least in part, on said estimate of said location of said second mobile device.

23. The apparatus of claim 22, wherein said at least one processor further programmed with instructions to:
detect a presence of a third mobile device and a fourth mobile device located in close proximity to said first mobile device, said third and said fourth mobile devices having a higher positioning capability relative to said first mobile device;
communicate indications of said detected presence of said third mobile device and said fourth mobile device to said server via said wireless communications network;
receive estimates of locations of said third and said fourth mobile devices from said server based, at least in part, on said indications; and
measure ranges to said second, third, and fourth mobile devices based, at least in part, on said estimates of said locations of said second, third, and fourth mobile devices.

24. The apparatus of claim 23, wherein said at least one processor further programmed with instructions to:
compute an estimated location of said first mobile device via at least one of the following: a trilateration operation based, at least in part, on said received estimates of locations of said second, third, and said fourth mobile devices and said ranges; a computation of a centroid based, at least in part, on said received estimates of locations of said second, third, and said fourth mobile devices and said ranges; or any combination thereof.

25. The apparatus of claim 23, wherein said instructions to detect said presence of said second, third, and fourth mobile devices comprises instructions to detect one or more peer-to-peer-type wireless communication links provided by said second, third, and fourth mobile devices.

26. The apparatus of claim 25, wherein said one or more peer-to-peer-type wireless communication links are part of a short-range wireless communications network that comprises at least one of the following: a homogeneous wireless communications network; a hybrid wireless communications network; or any combination thereof.

27. The apparatus of claim 23, wherein said ranges are measured based, at least in part, a type of a network of short-range peer-to-peer-type wireless communication links provided by said second, third, and fourth mobile devices.

28. An apparatus comprising:
means for detecting, at a first mobile device, a presence of a second mobile device in close proximity to said first mobile device, said second mobile device having a higher positioning capability relative to said first mobile device;
means for communicating an indication of said detected presence of said second mobile device to a server via a wireless communications network;
means for receiving an estimate of a location of said second mobile device from said server based, at least in part, on said indication; and
means for computing an estimated location of said first mobile device based, at least in part, on said estimate of said location of said second mobile device.

29. The apparatus of claim 28, and further comprising:
means for detecting a presence of a third mobile device and a fourth mobile device in close proximity to said first mobile device, said third and said fourth mobile devices having a higher positioning capability relative to said first mobile device;
means for communicating indications of said detected presence of said third mobile device and said fourth mobile device to said server via said wireless communications network;
means for receiving estimates of locations of said third and said fourth mobile devices from said server based, at least in part, on said indications; and
means for measuring ranges to said second, third, and fourth mobile devices based, at least in part, on said estimates of said locations of said second, third, and fourth mobile devices.

30. The apparatus of claim 29, and further comprising:
means for computing an estimated location of said first mobile device via performing at least one of the following: a trilateration operation based, at least in part, on said received estimates of locations of said second, third, and said fourth mobile devices and said ranges; a computation of a centroid based, at least in part, on said received estimates of locations of said second, third, and said fourth mobile devices and said ranges; or any combination thereof.

31. The apparatus of claim 29, and further comprising:
means for receiving a coarse location of said first mobile device from said server via said wireless communications network, said coarse location of said first mobile device being determined via at least one of the following: a recent position fix obtained via an SPS; a proximity to one or more wireless transmitters; a user input; or any combination thereof.

32. The apparatus of claim 29, wherein said means for detecting said presence of said second, third, and fourth mobile devices comprise means for detecting one or more peer-to-peer-type wireless communication links provided by said second, third, and fourth mobile devices.

33. The apparatus of claim 29, wherein said one or more peer-to-peer-type wireless communication links are part of a short-range wireless communications network that comprises at least one of the following: a homogeneous wireless communications network; a hybrid wireless communications network; or any combination thereof.

34. The apparatus of claim 33, wherein said short-range wireless communications network comprises at least one of the following: a Bluetooth®-type network; a Home Radio Frequency (RF)-type network; a ZigBee®-type network; an infrared radiation (IR)-type network; an ultrasound identification-type network; an active Radio-Frequency Identification (RFID)-type network; an RF-type network; or any combination thereof.

35. The apparatus of claim 29, wherein said means for detecting said presence of said second, third, and fourth mobile devices comprises means for processing one or more wireless signals received from said server via said wireless communications network.

36. The apparatus of claim 29, wherein said indications of said detected presence of said second, third, and fourth mobile devices comprise at least one of the following: a media access control (MAC) address; a network access ID; a mobile ID number; a wireless carrier subscription number; mobile device identification information; or any combination thereof.

37. The apparatus of claim 28, wherein said wireless communications network comprises at least one of the following: a homogeneous wireless communications network; a hybrid wireless communications network; or any combination thereof.

38. The apparatus of claim 28, wherein said wireless communications network comprises a WiFi-type network.

39. The apparatus of claim 28, wherein said wireless communications network is associated with an indoor environment.

40. The apparatus of claim 39, wherein said indoor environment comprises an environment where wireless signals from a satellite positioning system (SPS) are unavailable.

41. The apparatus of claim 29, wherein said locations of said second, third, and fourth mobile devices are estimated based, at least in part, on at least one of the following: a received signal strength indicator (RSSI); a round-trip delay time (RTT); or any combination thereof.

42. The apparatus of claim 29, wherein said first, second, third, and fourth mobile devices subscribe to service from at least one of the following: the same wireless carrier; different wireless carriers; or any combination thereof.

43. The apparatus of claim 29, wherein said ranges are measured based, at least in part, a type of a network of short-range peer-to-peer-type wireless communication links provided by said second, third, and fourth mobile devices.

44. An article comprising:
a non-transitory storage medium having instructions stored thereon executable by a computing platform to:
detect, at a first mobile device, a presence of a second mobile device in close proximity to said first mobile device, said second mobile device having a higher positioning capability relative to said first mobile device;
communicate an indication of said detected presence of said second mobile device to a server via a wireless communications network;
receive an estimate of a location of said second mobile device from said server based, at least in part, on said indication; and
compute an estimated location of said first mobile device based, at least in part, on said estimate of said location of said second mobile device.

45. The article of claim 44, wherein said storage medium further comprises instructions to:
detect a presence of a third mobile device and a fourth mobile device in close proximity to said first mobile device, said third and said fourth mobile devices having a higher positioning capability relative to said first mobile device;
communicate indications of said detected presence of said third mobile device and said fourth mobile device to said server via said wireless communications network;
receive estimates of locations of said third and said fourth mobile devices from said server based, at least in part, on said indications; and
measure ranges to said second, third, and fourth mobile devices based, at least in part, on said estimates of said locations of said second, third, and fourth mobile devices.

46. The article of claim 45, wherein said storage medium having said instructions to said detect said presence of said second, third, and fourth mobile devices further comprises instructions to detect one or more peer-to-peer-type wireless communication links provided by said second, third, and fourth mobile devices.

47. The article of claim 46, wherein said one or more peer-to-peer-type wireless communication links are part of a short-range wireless communications network that comprises at least one of the following: a homogeneous wireless communications network; a hybrid wireless communications network; or any combination thereof.

48. The article of claim 45, wherein said ranges are measured based, at least in part, a type of a network of short-range peer-to-peer-type wireless communication links provided by said second, third, and fourth mobile devices.
